(19) United States
(12) Patent Application Publication
(10) Pub. No.: US 2013/0262673 A1
(43) Pub. Date: Oct. 3, 2013

(54) SYSTEM AND METHOD OF MULTIPLE LOGIN OVERLAY FROM A SINGLE BROWSER INTERFACE

(71) Applicants: Steven HALL, Palo Alto, CA (US); Allen PORTER, San Jose, CA (US); Jonathan Samuel SERGENT, Menlo Park, CA (US)

(72) Inventors: Steven HALL, Palo Alto, CA (US); Allen PORTER, San Jose, CA (US); Jonathan Samuel SERGENT, Menlo Park, CA (US)

(73) Assignee: GOOGLE INC., Mountain View, CA (US)

(21) Appl. No.: 13/438,447

(22) Filed: Apr. 3, 2012

(51) Int. Cl. G06F 15/173

(52) U.S. Cl. 709/225

(57) ABSTRACT

A system and method for managing multiple user account login from a single browser interface using a cookie. The method includes receiving a request from a client device for electronic document data, receiving at least one cookie from the client device that identifies multiple user names logged into the system, fetching the electronic document data from the system associated with each of the multiple user names received from the client device, and sending the fetched electronic document data associated with each of the multiple user names to the client device for display.

### BACKGROUND

1. Field of the Disclosure

The present invention generally relates to a system and method of managing multiple account login in a single browser interface.

2. Background Information

Computer networks play a significant role in our lives, as more people gain access to the computer networks (e.g., the Internet) and people use the computer networks for more activities. Increasingly, people use more than one account (e.g., email addresses) in accessing resources on the computer networks. For example, one account may be for personal email, while a second account may be for work related emails.

Login is a process to control access to computer systems, commonly used for authenticating authorized users in accessing computer systems over computer networks. A login process can be used to provide protection from access by unauthorized users. In addition, the login process can be used to identify respective users such that information relevant to the respective users can be provided.

Cookies in web browsers are widely used to manage or facilitate login sessions over the computer networks. However, traditional cookies are not designed to manage multiple logins (sometimes herein called concurrently active logins), under multiple user names, from a single browser to a single web site. Therefore, there is a need for a new method and system for managing multiple logins, under multiple user names, from a single browser to a single web site.

### SUMMARY OF THE DISCLOSURE

The present disclosure, through one or more of its various aspects, embodiments, and/or specific features or sub-components, provides various systems, servers, methods, media, and programs for interfacing compiled codes, such as, for example, JavaScript scripts.

In one embodiment of the disclosure, there is a computer-implemented method for multiple user account log-in into a system using a single interface, including receiving a request from a client device for electronic document data; receiving at least one cookie from the client device that identifies multiple user accounts logged into the system; fetching the electronic document data from the system associated with each of the multiple user accounts received from the client device; and sending the fetched electronic document data associated with each of the multiple user account to the client device for simultaneous display on the single interface.

In another embodiment of the disclosure, there is a server for multiple user account log-in into a system using a single interface, including memory storing one or more programs for execution by at least one processor, the at least one processor executing that one or more programs to: receive a request from a client device for electronic document data; receive at least one cookie from the client device that identifies multiple user accounts logged into the system; fetch the electronic document data from the system associated with each of the multiple user accounts received from the client device; and send the fetched electronic document data associated with each of the multiple user account to the client device for simultaneous display on the single interface.

In still another embodiment of the disclosure, there is a non-transitory computer readable medium storing instructions to allow multiple user account log-in into a system using a single interface, the instructions when executed by a processor, including receiving a request from a client device for electronic document data; receiving at least one cookie from the client device that identifies multiple user accounts logged into the system; fetching the electronic document data from the system associated with each of the multiple user accounts received from the client device; and sending the fetched electronic document data associated with each of the multiple user account to the client device for simultaneous display on the single interface.

In one aspect, the multiple user accounts include at least a first user account and a second user account, the first user account and second user account having different domains.

In another aspect, the at least one cookie is a pointer to a server-side database and identifies a list of accounts associated with at least one user.

In yet another aspect, the at least one cookie includes multiple cookies, each of the multiple cookies associated with at least one of the multiple user accounts logged into the system.

In still another aspect, the fetched electronic document data is a subset of the electronic data associated with each of the multiple user accounts.

In another aspect, the user can toggle between any one or more of the multiple user accounts logged into the system for simultaneous display on the client device.

In another aspect, the single interface is at least one of a browser, calendar, spreadsheet, electronic document, email interface, application, photographs, social media interface.

In yet another aspect, the electronic document data associated with each of the multiple user accounts is stored in respective storage locations accessible by the system.

In still another aspect, the method further includes authenticating the multiple user accounts and fetching the electronic document data associated with the multiple user accounts that have been authenticated.

### BRIEF DESCRIPTION OF THE DRAWINGS

The present invention is further described in the detailed description which follows, in reference to the noted plurality of drawings, by way of non-limiting examples of preferred embodiments of the present invention, in which like characters represent like elements throughout the several views of the drawings.

FIG. 1 is an exemplary system for use in accordance with the embodiments described herein.

FIG. 2 is a block diagram illustrating an exemplary distributed computer system, according to certain embodiments.

FIG. 3 illustrates an exemplary operational flow of a single user account log-in from the perspective of a client and server.

FIG. 4 illustrates an exemplary operational flow diagram for a multiple account user log-in from the perspective of a client and server.

FIGS. 5A-5D illustrate exemplary embodiments of a multiple log-in interface associated with the instant system.

FIG. 6 illustrates an exemplary operational flow diagram for a multiple account user log-in with an overlay feature from the perspective of a client and server.

FIGS. 7A-7C illustrate exemplary embodiments of a multiple log-in with overlay interface associated with the instant system.

FIG. 8 show an exemplary flow diagram illustrating the process performed by a client and server in accordance with an embodiment of the disclosure.

FIG. 9 illustrates an exemplary flow diagram of managing multiple log-in with an overlay feature in accordance with embodiments of the disclosure.

### DETAILED DESCRIPTION

The present disclosure, through one or more of its various aspects, embodiments and/or specific features or sub-components, is thus intended to bring out one or more of the advantages as specifically noted below.

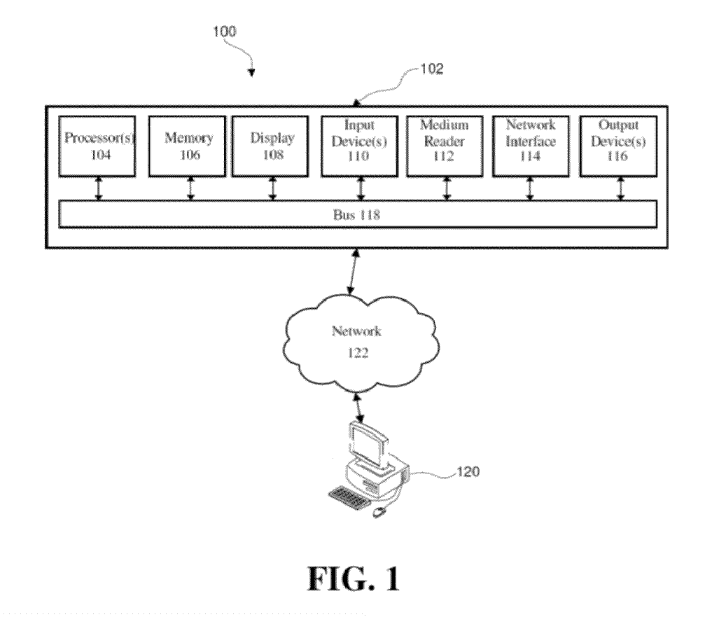

FIG. 1 is an exemplary system for use in accordance with the embodiments described herein. The system 100 is generally shown and may include a computer system 102, which is generally indicated. The computer system 102 may operate as a standalone device or may be connected to other systems or peripheral devices. For example, the computer system 102 may include, or be included within, any one or more computers, servers, systems, communication networks or cloud environment.

The computer system 102 may operate in the capacity of a server in a network environment, or the in the capacity of a client user computer in the network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless telephone, a personal trusted device, a web appliance, or any other machine capable of executing a set of instructions (sequential or otherwise) that specify actions to be taken by that device. Further, while a single computer system 102 is illustrated, addition embodiments may include any collection of systems or sub-systems that individually or jointly execute instructions or perform functions.

As illustrated in FIG. 1, the computer system 102 may include at least one processor 104, such as, for example, a central processing unit, a graphics processing unit, or both. The computer system 102 may also include a computer memory 106. The computer memory 106 may include a static memory, a dynamic memory, or both. The computer memory 106 may additionally or alternatively include a hard disk, random access memory, a cache, or any combination thereof. Of course, those skilled in the art appreciate that the computer memory 106 may comprise any combination of known memories or a single storage.

As shown in FIG. 1, the computer system 102 may include a computer display 108, such as a liquid crystal display, an organic light emitting diode, a flat panel display, a solid state display, a cathode ray tube, a plasma display, or any other known display.

The computer system 102 may include at least one computer input device 110, such as a keyboard, a remote control device having a wireless keypad, a microphone coupled to a speech recognition engine, a camera such as a video camera or still camera, a cursor control device, or any combination thereof. Those skilled in the art appreciate that various embodiments of the computer system 102 may include multiple input devices 110. Moreover, those skilled in the art further appreciate that the above-listed, exemplary input devices 102 are not meant to be exhaustive and that the computer system 102 may include any additional, or alternative, input devices 110.

The computer system 102 may also include a medium reader 112 and a network interface 114. Furthermore, the computer system 102 may include any additional devices, components, parts, peripherals, hardware, software or any combination thereof which are commonly known and understood as being included with or within a computer system, such as, but not limited to, an output device 116. The output device 116 may be, but is not limited to, a speaker, an audio out, a video out, a remote control output, or any combination thereof.

Each of the components of the computer system 102 may be interconnected and communicate via a bus 118. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, or any other network commonly known and understood in the art. The network 122 is shown in FIG. 1 as a wireless network. However, those skilled in the art appreciate that the network 122 may also be a wired network.

The additional computer device 120 is shown in FIG. 1 as a personal computer. However, those skilled in the art appreciate that, in alternative embodiments of the present application, the device 120 may be a laptop computer, a tablet PC, a personal digital assistant, a mobile device, a palmtop computer, a desktop computer, a communications device, a wireless telephone, a personal trusted device, a web appliance, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

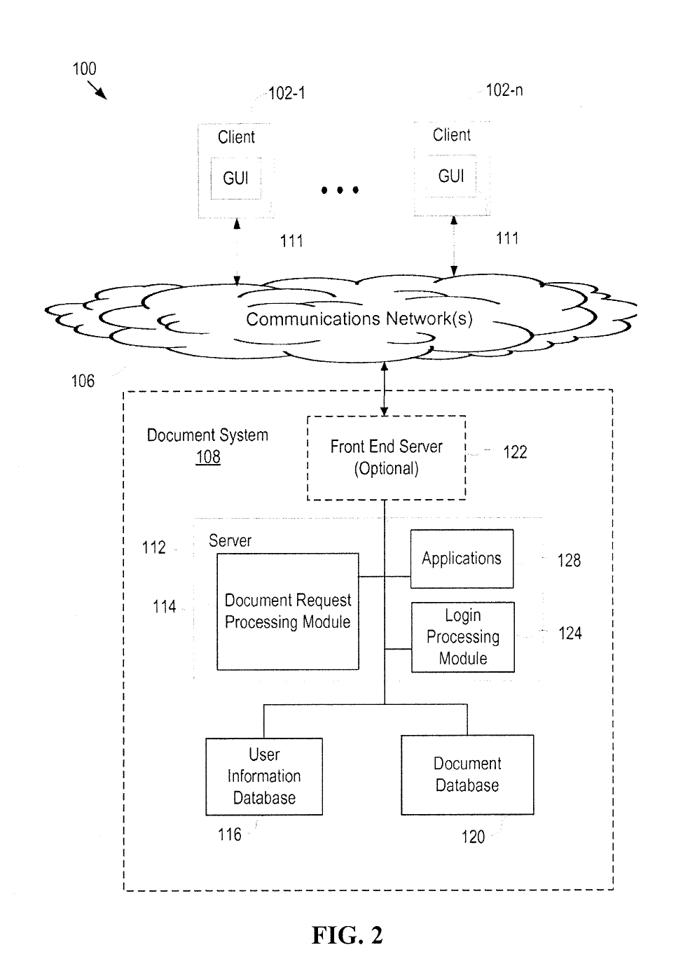

FIG. 2 is a block diagram illustrating an exemplary distributed computer system 100, according to certain embodiments. In FIG. 2, system 100 includes one or more client computers 102, a communications network 106, and a document system 108. Various embodiments of the document system 108 implement the login methods described in this document.

Client computers 102 can be any of a number of computing devices (e.g., Internet kiosk, personal digital assistant, cell phone, gaming device, desktop computer, laptop computer, handheld computer, or combinations thereof) used to enable the activities described below. Client computer(s) 102 is also referred to herein as client(s). Client 102 typically includes a graphical user interface (GUI) 111. Client 102 is connected to the document system 108 via communications network 106. As described in more detail below, the GUI 111 is used to display electronic document data (or document information) and login pages. The document system 108 provides document services (e.g., document authoring, editing, sharing, mailing, and viewing services) to a community of users (e.g., the employees of a company, the members of an organization or group, friends, family members, etc.) who access the document system 108 from the clients 102.

Document system 108 includes one or more servers, such as server 112, connected to the communications network 106. Optionally, the one or more servers are connected to the communications network 106 via a front end server 122 (e.g., a server that conveys (and optionally parses) inbound requests to the appropriate server of the system 108, and that formats responses and/or other information being sent to clients in response to requests). The front end server 122, if present, may be a web server providing web based access to the document system 108. The front end server 122, if present, may also route communications to and from other destinations, such as a remote document server.

Document system 108 includes a user information database 116, and a document database 120. In some embodiments, the document system 108 also includes or has access to one or more other databases, such as a login database (not shown), which maintains login information. Server 112 includes a document request processing module 114, a login processing module 124, and applications 128. Server 112 communicates with databases internal to the document system 108, such as user information database 116, and document databases 120, and in some embodiments, a login database (not shown) using a local area network, by internal communication busses, or by any other appropriate mechanism or combination of mechanism.

Server 112 communicates with clients 102 via the front end server 122 (if present) and communication network(s) 106. In some embodiments, the communications network 106 is the Internet. In other embodiments, the communication network 106 can be any local area network (LAN), wide area network (WAN), metropolitan area network, or a combination of such networks. In some embodiments, server 112 is a web server that manages document requests using appropriate communication protocols. Alternatively, if server 112 is used within an intranet, it may be an intranet server.

Applications 128 include application programs used for managing an online document system. In some embodiments, applications 128 also include a user information processing module, where the user information processing module assists in accessing and updating user information database 116. User information database 116 stores various information associated with the users of the document system 108, including user preferences, display styles, and optionally other information such as login information. In some embodiments, a login database (not shown) stores the login information. Document database 120 store information concerning various types of documents as well as data (e.g., document contents).

Document request processing module 114 retrieves stored document information. Document request processing module 114 assists in accessing and updating document database 120, and in some embodiments, user information database 116. In some other embodiments, document request processing module 124 also assists in accessing and updating a login database (not shown).

In some embodiments, document database 120 stores information (e.g., metadata) concerning various documents in the document database. A non-exhaustive set of examples of such information includes document ID, author, access control list, timestamps (e.g., timestamps for one or more of creation date, revision history, last updated time, last accessed time, etc.), and document type (e.g., word processor document, spreadsheet, presentation file, etc.). In some embodiments, document database 120 also stores document data (e.g., contents) or information about a location of document data (e.g., a pointer to a remote server).

In some embodiments, the user information database 116 includes user information records having information relevant to the display of document information. For example, the user information record for a respective user may include, in addition to identifying information for the user, document folders, and default display settings (e.g., display a particular document, content of a particular folder, a list of documents associated with a particular document processing application (e.g., a word processor, spreadsheet, or presentation application), or a list of all documents).

In essence, server 112 is configured to manage certain aspects of document system 108, including managing login requests from a respective client 102.

Optionally, document system 108 is implemented as part of a document sharing system that provides document services (e.g., document authoring, editing, sharing, mailing, and viewing services) to a community of users (e.g., the employees of a company, the members of an organization or group, etc.).

In some embodiments, fewer and/or additional modules, functions or databases are included in document system 108 and server 112. The modules shown in document system 108 and server 112 represent functions performed in certain embodiments.

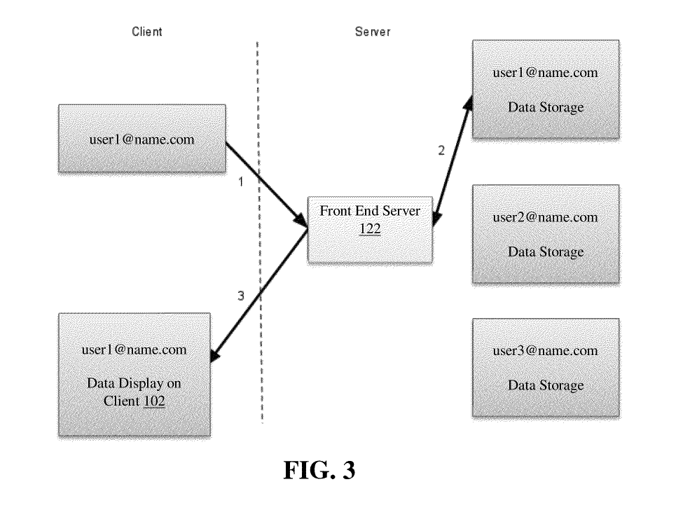

A standard mechanism for authenticating requests for logged-in user accounts on a network, such as the network depicted in FIGS. 1 and 2, is to set a cookie that identifies the logged-in (or signed-in) user account of a client 102. As understood, a cookie (or HTTP cookie, web cookie or browser cookie) is used for an originating website to send information to a user's browser, and for the browser to return information to the originating site. The information can include, for example, user authentication information (as in the current example), user session identification, user preference, shopping cart contents or anything accomplished by storing data on the user's computer. For example, FIG. 3 illustrates an exemplary operational flow of a single user account log-in from the perspective of a client 102 and server 112 via front end server 122 (which is optional). In this example, client 102 includes a cookie with information associated with user1@name.com, which client 102 is logged-in. For a client 102 to access electronic data (such as electronic document data) associated with their account, the client 102 requests the electronic document data. A cookie including the user information is sent to front end server 122 at (1). The request (which identifies the user account name) and cookie are received by the front end server 122, which authenticates the client 102 and fetches the requested electronic document data from user information database 116 and/or document database 120 at (2) (If client 102 is not authenticated, a log-in page is returned to the user to re-enter the log-in information). The fetched data is sent to the client 102 for display on client 102 at (3). Also depicted in the figure are data storage devices for multiple user accounts. For example, user2@name.com and user2@name.com, each of which represent another account belonging to the user of user1@name.com. However, in a single user log-in account, a user must log-off from one account (e.g. user1@name.com) in order to sign into another account (e.g. user2@name.com or user3@name.com), as readily understood.

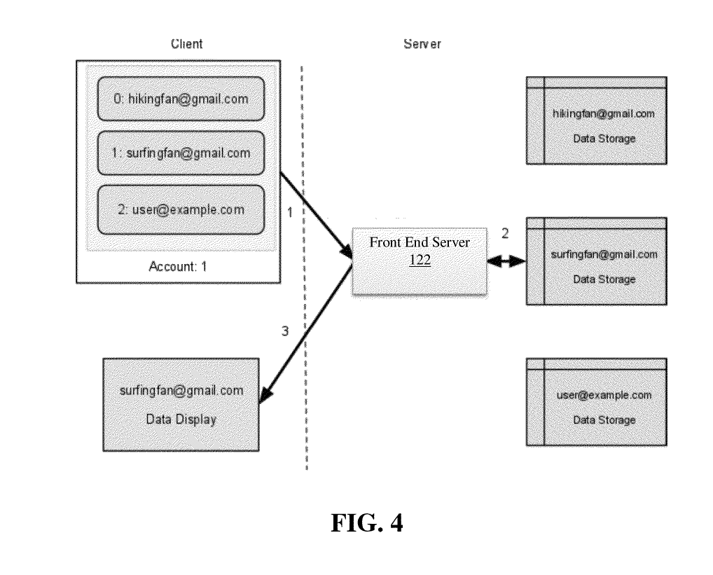

FIG. 4 illustrates an exemplary operational flow diagram for a multiple user account log-in from the perspective of a client 102 and server 112 via front end server 122. In the exemplary embodiments that follow, user1@name.com, user2@name.com and user3@name.com are replaced with hikingfan@gmail.com, surfingfan@gmail.com and user@example.com, respectively. It is understood that the email addresses are for exemplary purposes, and any email address or user account name may be used. In this example, client 102 includes a cookie with information associated with multiple accounts, namely hikingfan@gmail.com, surfingfan@gmail.com and user@example.com, each of which accounts is logged-in. In order to authenticate requests of a single user having logged-in to multiple accounts, the cookie includes information for each of the accounts, and the request identifies which of the multiple accounts the user has selected. That is, with multiple account log-in, a user of client 102 selects one of the accounts for authentication and data fetching in advance of the system performing any operation. For example, for a client 102 to access electronic data (such as electronic document data) associated with one of the accounts, the client 102 selects one of the accounts (e.g. surfingfan@gmail.com) and requests the electronic document data. A single cookie (e.g. Account: 1) including user information for each of the accounts is sent at (1). It is appreciated that although a single cookie is being used in the exemplary embodiment, multiple cookies may be used. Moreover, instead of using a cookie(s) with embedded account information, the cookie could be a pointer to a server-side database of a list(s) of accounts or a cookie index. The request and cookie are received by the front end server 122 (which is optional as explained above), which authenticates the client 102 and fetches the requested electronic document data from user information database 116 and/or document database 120 associated with the selected one of the multiple accounts at (2). The fetched data is returned to the client 102 display for viewing by the user on client 102 at (3). While data for each of the multiple accounts stored in the cookie is sent to the front end server 122, it is the information for the selected account that is fetched and displayed on client 102. For example, in the exemplary embodiment, the data associated with surfingfan@gmail.com is selected by the user at the client 102. The cookie associated with all user accounts is sent to the front end server 122, which then retrieves account data for the specified account (i.e. surfingfan@gmail.com). The fetched account data is then displayed on the display of client 102. Also depicted in the figure are data storage devices for the other user accounts. For example, hikingfan@gmail.com and user@example.com, each of which represent another account also belonging to the user of surfingfan@gmail.com. Unlike a single user account log-in, with a multiple user account log-in, a user need not log-off of one account (e.g. surfingfan@gmail.com) in order to sign into another account (e.g. hikingfan@gmail.com or user example.com). Rather, a user may simply select any one of the multiple user accounts to access electronic document data associated therewith, as provided in the illustrations that follow.

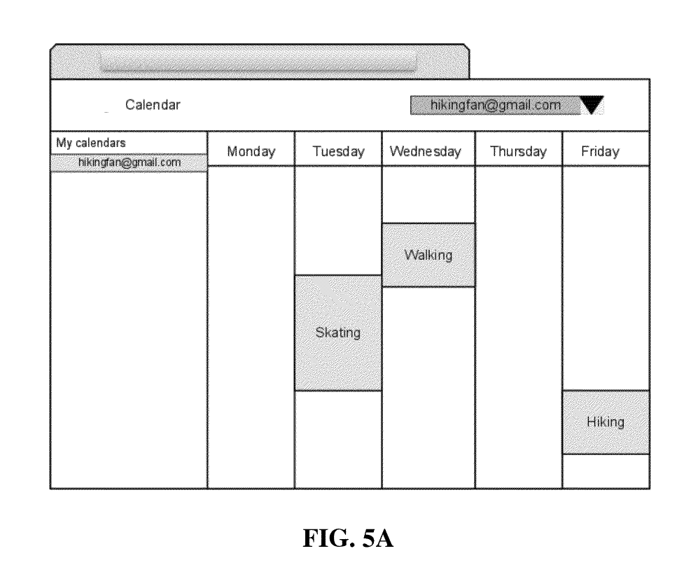

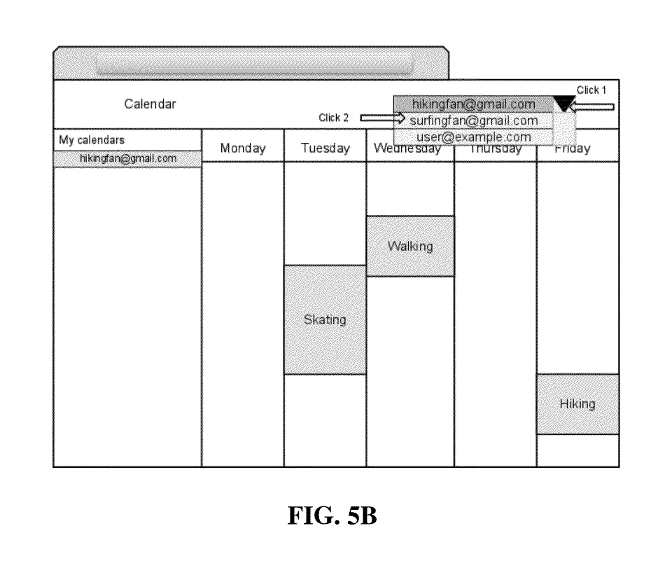

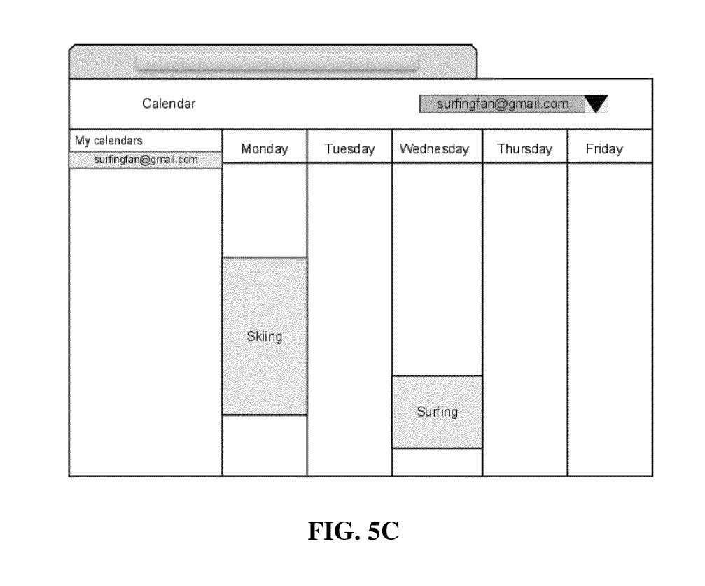

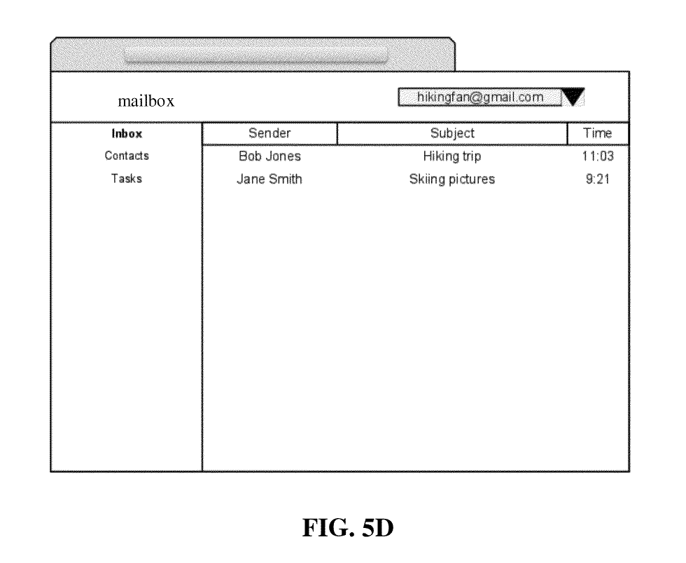

FIGS. 5A-5D illustrate exemplary embodiments of a multiple log-in interface associated with the instant system. With the multiple log-in interface, a single account is displayed at one time, although a drop down menu (or similar) allows the display to switch between accounts. FIG. 5A shows an interface displaying electronic document data on a client 102 display. In this example, the electronic document data is a calendar displaying various user event data for hikingfan@gmail.com, such as skating, walking and hiking. As illustrated in FIG. 5B, a drop down menu allows a user at client 102 to select any one of the multiple accounts logged-in to by the user. It is appreciated that although a drop down menu is illustrated in the disclosed embodiment, selection of user accounts may be performed in any number of manners as readily understood by the skilled artisan. For example, the user may select to view the account surfingfan@gmail.com instead of hikingfan@gmail.com. Selection of the account surfingfan@gmail.com will display the data associated therewith, as illustrated in FIG. 5C. For example, upon selection of the account surfingfan@gmail.com, the electronic document content switches to display user event data associated with the newly selected account. In this case, the calendar displays skiing and surfing. FIG. 5D is an exemplary email display of a multiple log-in interface associated with the instant system. Similar to the calendar display illustrated in FIGS. 5A-5C, a user can toggle between multiple logged-in accounts. For example, if a user is logged in to the hikingfan@gmail.com account, the interface displays email messages corresponding only to the selected account. A pull-down menu (indicated by the upside down arrow in the upper right hand corner) may be used by the user to toggle between any one of the other logged-in multiple accounts. For example, the user may toggle between hikingfan@gmail.com, surfingfan@gmail.com and user@example.com.

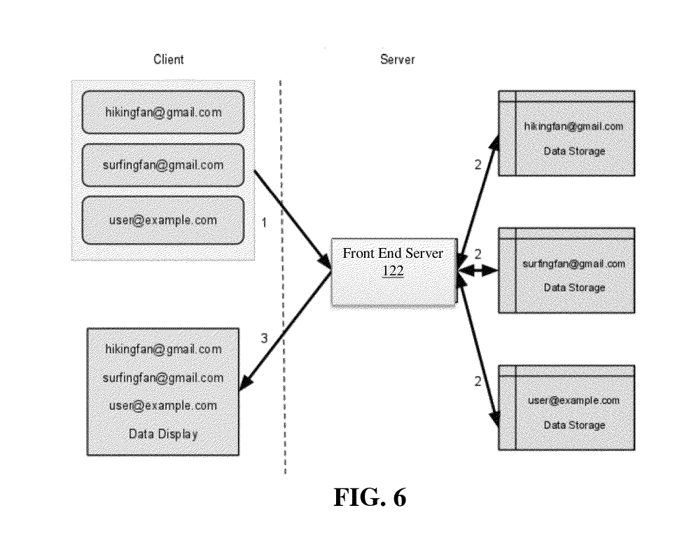

FIG. 6 illustrates an exemplary operational flow diagram for a multiple account user log-in with an overlay feature from the perspective of a client 102 and server 112. With multiple account log-in having an overlay feature (i.e. a feature that allows multiple accounts of single user to be displayed simultaneously, whether all of the accounts or less than all of the accounts), a user of client 102 selects one of the accounts for authentication in advance of the system performing any operation. That is, for a client 102 to access electronic data (such as electronic document data) associated with one of the accounts, the client 102 selects one, some or all of the accounts (e.g. the user selects accounts hikingfan@gmail.com, surfingfan@gmail.com and/or surfingfan@gmail.com) and requests the electronic document data associated with each of the selected accounts. A single cookie including user information for each of the accounts is sent at (1). It is appreciated that although a single cookie is being used in the exemplary embodiment, multiple cookies may be used. Moreover, instead of using a cookie(s) with embedded account information, the cookie could be a pointer to a server-side database of a list(s) of accounts or a cookie index. Additionally, the cookie may include a subset of account information (for example, the user logs-into or selects fewer than all accounts available). The request and cookie are received by the front end server 122 (which is optional as explained above), which authenticates the client 102 and fetches the requested electronic document data from user information database 116 and/or document database 120 associated with each of the selected multiple accounts at (2). Here, unlike the multiple log-in account, the front end server 122 fetches/retrieves data for each of the selected accounts (as depicted in the figure by the three arrows labeled “2”). The fetched data is returned to the client 102 display for viewing by the user on client 102 at (3). Since data for each of the multiple accounts stored in the cookie is sent to the front end server 122, information for each of the selected account is fetched, returned and may be displayed on client 102. For example, in the exemplary embodiment, the data associated with hikingfan@gmail.com, surfingfan@gmail.com and user@example.com is selected by the user at the client 102. The cookie associated with all user accounts is sent to the front end server 122, which then retrieves account data for each of the specified accounts. The fetched account data is then displayed on the display of client 102. It is appreciated that not all of the fetched data has to be fetched and returned to client 102 and displayed on the display of client 102. Rather, the user may elect to have a subset of the data fetched and/or displayed, or select any number of accounts for fetching data and display at a time. Since all account data may be fetched from associated data storages (data storages for each account) by the front end server 122, the user may select which accounts and corresponding data to display on client 102. The ability to select which account to display may be performed using any method readily understood by the skilled artisan, and is not limited to the disclosed embodiments.

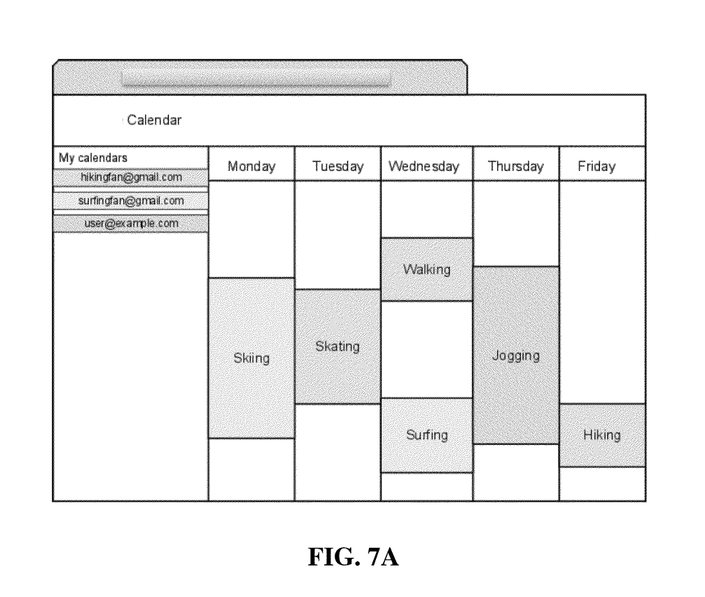

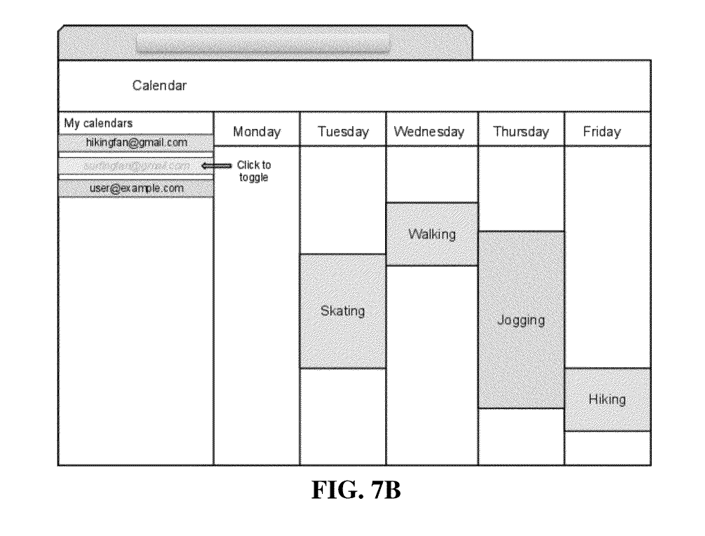

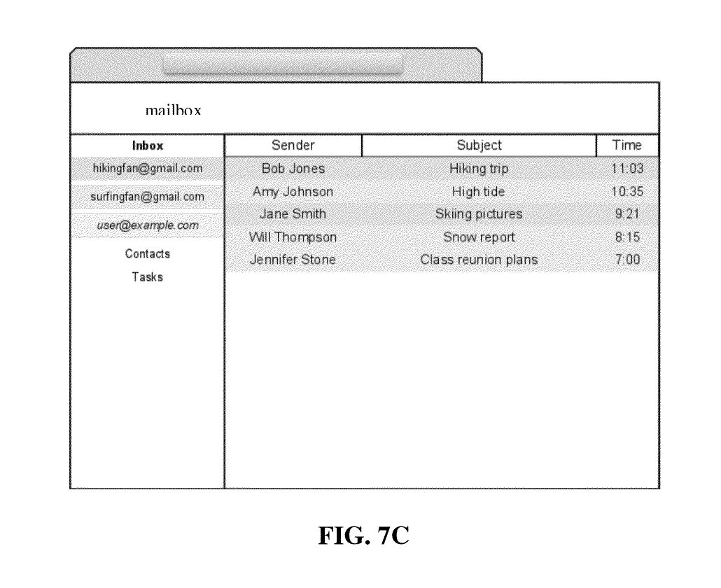

FIGS. 7A and 7B illustrate exemplary embodiments of a multiple log-in with overlay interface associated with the instant system. In the exemplary illustrated embodiment of FIG. 7A, the display (e.g., interface) of client 102 displays a calendar. On the left most column of the calendar, multiple accounts are listed for the user. That is, in the exemplary embodiment, the left most column of the single interface (i.e. browser) displays a tab of each of user accounts hikingfan@gmail.com, surfingfan@gmail.com and user@example.com. Each account, as previously explained, is associated with electronic document data stored in, for example, user information database 116 and/or document database 120. In the depicted example, the account associated with hikingfan@gmail.com includes user information including skating, walking and hiking; the account associated with surfingfan@gmail.com includes user information including skiing and surfing; and the account associated with user@example.com includes user information including jogging. Since all user accounts are logged-in and have been selected for display by the user in the exemplary embodiment, all of the user information is simultaneously displayed on the interface. A user need not select between various tabs or browser interfaces in order to view information for each of the different accounts. Rather, all information may be display at the same time on the same interface (e.g., browser interface). Advantageously, this provides the user with a seamless environment in which to display information from multiple accounts without having to switch between tabs or various interfaces. FIG. 7B is an exemplary embodiment of the interface illustrated in FIG. 7A, where the user has elected not to display user information associated with surfingfan@gmail.com. That is, the user has selected less than all of the accounts logged into. As depicted in the exemplary illustration, the user information associated with hikingfan@gmail.com and user@example.com is displayed on the interface. For example, skating, walking, jogging and hiking information are displayed. The user information (for example, skiing) associated with surfingfan@gmail.com, on the other hand, is no longer displayed. FIG. 7C is an exemplary email display of a multiple log-in interface with an overlay feature associated with the instant system. Similar to the calendar display illustrated in FIGS. 7A-7B, a user can display multiple logged-in email accounts simultaneously. For example, when a user is logged-in to the hikingfan@gmail.com, surfingfan@gmail.com and user@example.com accounts, the interface displays email messages corresponding to each one of the multiple accounts. A menu, shown on the left hand side of the interface, indicates which of the multiple user accounts are logged-in and currently being displayed. The user may select or deselect accounts for display. For example, the user may toggle between hikingfan@gmail.com, surfingfan@gmail.com and user@example.com or select any one or more accounts for simultaneous display. It is appreciated that the disclosure is not limited to the specific interface and illustrated embodiment. Rather, any interface may be used that is readily understood in the art. Moreover, the interface may provide any number of ways to select, toggle and move between various user accounts.

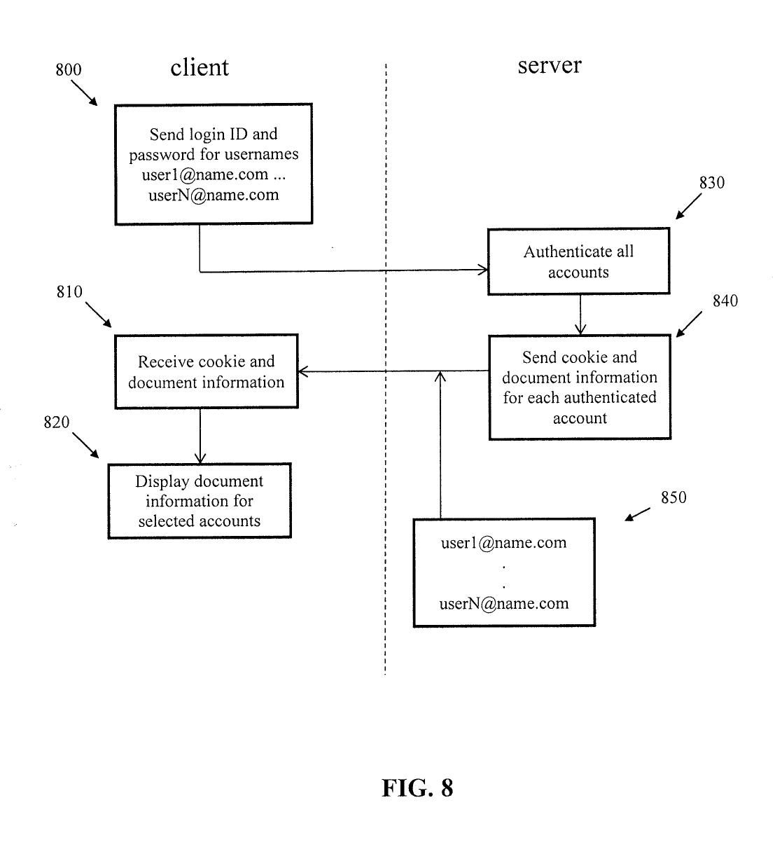

FIG. 8 show an exemplary flow diagram illustrating the process performed by a client and server in accordance with an embodiment of the disclosure. After a user has entered log-in information for his accounts, the login ID and password for the various user accounts (800) are sent from client 102 to document system 108 (and in this exemplary embodiment, to front end server 122) for authentication (830). If the client 102 is not authenticated by the document system 108 (e.g. the request did not include a valid cookie indicating that the user is authenticated for the document system 108), the document system 108 sends a log-in page to client 102 for re-entering log-in information. If, on the other hand, the user is authenticated (for example, by the login processing module 124 using the login ID and password at 840) by document system 108, then the cookie is sent back to client 102 along with document information associated with each of the user accounts having been authenticated. The client receives the cookie and document information (810), which is ready for display on the display of client 102 at 820.

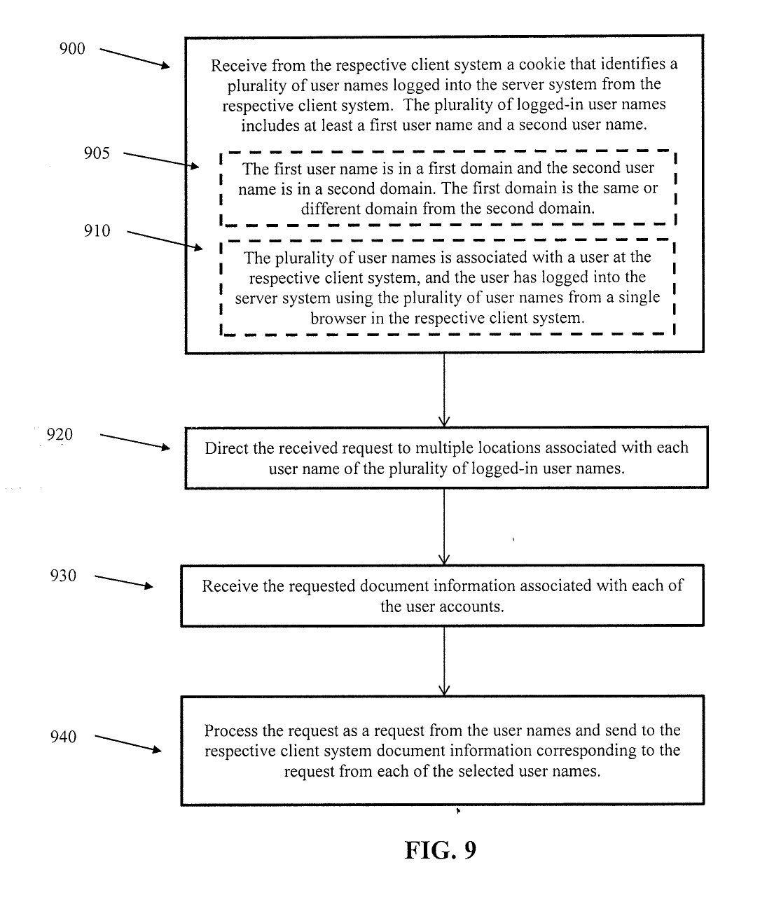

FIG. 9 illustrates an exemplary flow diagram of managing multiple log-in with an overlay feature in accordance with embodiments of the disclosure. The method is performed on, for example, a server system having one or more processors and memory storing one or more programs executed by the one or more processors (e.g., document system 108). The server system receives a request (e.g. or document information) from the respective client system a cookie that identifies a plurality of user names logged into the server system from the respective client system. In one example, the plurality of logged-in user names includes a first user name and a second user name (for example, hikingfan@gmail.com and surfingfan@gmail.com). In the exemplary embodiment, the first user name is in a first domain and the second user name is in a second domain, where the first and second domains are the same (905). However, the first and second domains may also be different or distinct from one another (for example, hikingfan@gmail.com and user@example.com). Moreover, the plurality of user names received in the cookie are associated with a single user at a single client system in the exemplary embodiment (910). Additionally, the user has logged into the server system using the plurality of user names from a single browser in the client system. It is appreciated, as described above, that the usernames need not be in the same cookie or logged into from a single browser. The server system then directs the received request to multiple locations (e.g. data storage) associated with each user name of the plurality of logged-in user names (920), and the requested document information is received back at the server system (930). In response to receiving the document information from the data storage, the request is processed as a request from the user names, and the respective clients system is sent document information corresponding to the request from each of the selected user names (940).

While the examples provided in the disclosed embodiments relate to calendar and email, the disclosure is not limited to such embodiments. Rather, the electronic data or electronic document data may include, but is not limited to, documents, news, photos, social networks, viewers, web browsers, voice or any other type of application or document as described in the aforementioned disclosure. Moreover, it is appreciated that although only three accounts from the same domain are used in the exemplary embodiment, any number of accounts from the same or a different domain may be used. Additionally, although the login process is described in the aforementioned embodiments, the process may also be applied to log-out.

Accordingly, the present invention provides various systems, servers, methods, media, and programs for generating a graphical comparison of data files. Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

While the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A computer-implemented method for multiple user account log-in into a system using a single interface, comprising:
receiving a request from a client device for electronic document data;
receiving at least one cookie from the client device that identifies multiple user accounts logged into the system;
fetching the electronic document data from the system associated with each of the multiple user accounts received from the client device; and
sending the fetched electronic document data associated with each of the multiple user account to the client device for simultaneous display on the single interface.

2. The computer-implemented method according to claim 1, wherein the multiple user accounts include at least a first user account and a second user account, the first user account and second user account having different domains.

3. The computer-implemented method according to claim 1, wherein the at least one cookie is a pointer to a server-side database and identifies a list of accounts associated with at least one user.

4. The computer-implemented method according to claim 1, wherein the at least one cookie includes multiple cookies, each of the multiple cookies associated with at least one of the multiple user accounts logged into the system.

5. The computer-implemented method according to claim 1, wherein the fetched electronic document data is a subset of the electronic data associated with each of the multiple user accounts.

6. The computer-implemented method according to claim 1, wherein the user can toggle between any one or more of the multiple user accounts logged into the system for simultaneous display on the client device.

7. The computer-implemented method according to claim 1, wherein the single interface is at least one of a browser, calendar, spreadsheet, electronic document, email interface, application, photographs, social media interface.

8. The computer-implemented method according to claim 1, wherein the electronic document data associated with each of the multiple user accounts is stored in respective storage locations accessible by the system.

9. The computer-implemented method according to claim 1, further comprising authenticating the multiple user accounts and fetching the electronic document data associated with the multiple user accounts that have been authenticated.

10. A server for multiple user account log-in into a system using a single interface, comprising:
memory storing one or more programs for execution by at least one processor, the at least one processor executing that one or more programs to:
receive a request from a client device for electronic document data;
receive at least one cookie from the client device that identifies multiple user accounts logged into the system;
fetch the electronic document data from the system associated with each of the multiple user accounts received from the client device; and
send the fetched electronic document data associated with each of the multiple user account to the client device for simultaneous display on the single interface.

11. The server according to claim 10, wherein the multiple user accounts include at least a first user account and a second user account, the first user account and second user account having different domains.

12. The server according to claim 10, wherein the at least one cookie is a pointer to a server-side database and identifies a list of accounts associated with at least one user.

13. The server according to claim 10, wherein the at least one cookie includes multiple cookies, each of the multiple cookies associated with at least one of the multiple user accounts logged into the system.

14. The server according to claim 10, wherein the fetched electronic document data is a subset of the electronic data associated with each of the multiple user accounts.

15. The server according to claim 10, wherein the user can toggle between any one or more of the multiple user accounts logged into the system for simultaneous display on the client device.

16. The server according to claim 10, wherein the single interface is at least one of a browser, calendar, spreadsheet, electronic document, email interface, application, photographs, social media interface.

17. The server according to claim 10, wherein the electronic document data associated with each of the multiple user accounts is stored in respective storage locations accessible by the system.

18. The server according to claim 10, the at least one processor further comprising authenticating the multiple user accounts and fetching the electronic document data associated with the multiple user accounts that have been authenticated.

19. A non-transitory computer readable medium storing instructions to allow multiple user account log-in into a system using a single interface, the instructions when executed by a processor, comprising:
receiving a request from a client device for electronic document data;
receiving at least one cookie from the client device that identifies multiple user accounts logged into the system;
fetching the electronic document data from the system associated with each of the multiple user accounts received from the client device; and
sending the fetched electronic document data associated with each of the multiple user account to the client device for simultaneous display on the single interface.

20. The server according to claim 19, wherein the multiple user accounts include at least a first user account and a second user account, the first user account and second user account having different domains.

21. The server according to claim 19, wherein the at least one cookie is a pointer to a server-side database and identifies a list of accounts associated with at least one user.

22. The server according to claim 19, wherein the at least one cookie includes multiple cookies, each of the multiple cookies associated with at least one of the multiple user accounts logged into the system.

23. The server according to claim 19 wherein the fetched electronic document data is a subset of the electronic data associated with each of the multiple user accounts.

24. The server according to claim 19, wherein the user can toggle between any one or more of the multiple user accounts logged into the system for simultaneous display on the client device.

25. The server according to claim 19, wherein the single interface is at least one of a browser, calendar, spreadsheet, electronic document, email interface, application, photographs, social media interface.

26. The server according to claim 19, wherein the electronic document data associated with each of the multiple user accounts is stored in respective storage locations accessible by the system.

27. The server according to claim 19, further comprising authenticating the multiple user accounts and fetching the electronic document data associated with the multiple user accounts that have been authenticated.
